(19) United States
(12) Patent Application Publication
(10) Pub. No.: US 2004/0247099 A1
(43) Pub. Date: Dec. 9, 2004

(54) Method for automatically dialling a telephone number

(76) Inventors: Benoit Brun, Plabennec (FR); Thierry Filoux, Plouzane (FR)

Correspondence Address: SUGHRUE MION, PLLC, 2100 PENNSYLVANIA AVENUE, N.W., SUITE 800, WASHINGTON, DC, 20037, US

(21) Appl. No.: 10/480,921

(22) PCT Filed: Jun. 20, 2002
(86) PCT No.: PCT/FR02/02141

(30) Foreign Application Priority Data
Jun. 21, 2001 (FR) 01/08182

(51) Int. Cl. H04M 11/00; H04M 1/00

(52) U.S. Cl. 379/100.14; 379/355.01; 379/90.01

(57) ABSTRACT

The invention relates to a method of automatically dialing a telephone number from a string of characters constituted by the number or by a subscriber name corresponding to the number, the string being found in a document displayed on a computer screen. The method consists essentially in using optical character recognition. The invention is applicable to computer-assisted telephony.

The invention relates to a method of automatically dialing a telephone number from a character string constituted by the number, or by the name of the subscriber corresponding to the number, and encountered in a document displayed on a computer screen.

Number-dialing software is known that enables a telephone call to be set up from a computer, e.g. when a user consults an electronic directory, the directory containing a list of subscriber names associated with respective telephone numbers stored in a digital format. It suffices to click on the zone of the screen that displays a subscriber's name or number, for said number to be sent in a digital format to a software module for dialing the number, which module transforms each digit into dialing signals that are sent over a telephone line connected to the computer.

Software is known for dialing a telephone number from a computer by consulting an electronic document (e.g. a Word document) made up of characters stored in a digital format, i.e. in which each character is encoded by a binary word. It suffices to select a string of digits constituting a telephone number on the screen and then to copy it into an electronic clipboard, and then paste it into a window of a number-dialing software module. Unfortunately, that known method is not usable when the number is encoded in a graphics format, because it is a graphics portion of a web page or because it is part of a fax. Under such circumstances, an image of each digit is available but there is no code word (e.g. on 8 bits) encoding the digit. It is necessary to copy the number manually into a window of a number-dialing software module, and then launch dialing.

U.S. Pat. No. 5 903 631 describes a method consisting in:

designating a screen zone that displays a string of characters containing a number for dialing in a graphics format; and giving the order to dial a corresponding telephone number;

recognizing each character in the displayed string by means of an optical character recognition method, determining which characters are digits, and converting them from a graphics format into a digital format;

and then supplying the digits in said digital format to telephone number dialing software and causing it to dial the number.

That known method is advantageous for quickly telephoning someone whose telephone number is mentioned in a fax, for example. However, if only the name of the person is mentioned in the fax, that method is not suitable. It is necessary to look up the telephone number in a directory. Opening a paper directory or an electronic directory, and then looking for the number from the name requires a non-negligible amount of time.

The object of the invention is to provide a method enabling a number to be dialed automatically from a string of characters displayed on a screen, in particular when the string comprises a number and is encoded in a graphics format.

The invention provides a method of automatically dialing a telephone number from a string of characters displayed on a computer screen, characterized in that it consists in

designating the zone of the screen that displays the string of characters corresponding to the number to be dialed, and giving the order to dial the corresponding telephone number;

recognizing each character in the displayed string using an optical character recognition method in order to convert the characters from a graphics format to a digital format;

determining a telephone number corresponding to the string of characters converted into digital format; and causing it to be confirmed by the user; and

supplying the digits corresponding to said number in a digital format to telephone number dialing software and causing it to dial the number;

the method being characterized in that in order to determine a telephone number corresponding to the character string, if at least some of the character string is constituted by a name, the method consists in looking up a telephone number corresponding to said name in a directory.

The method as characterized in this way enables a number to be determined even if the string of characters is an image representing a name, by establishing collaboration between the step of recognizing characters and a step of searching automatically in a directory.

The invention will be better understood and other characteristics will appear on reading the following description and the accompanying figures:

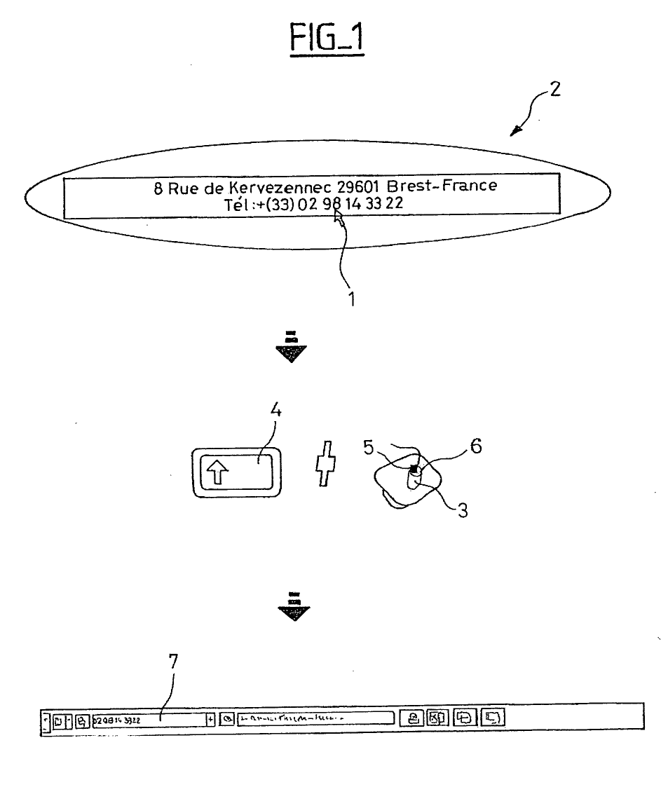

FIG. 1 shows a first implementation of the method of the invention;

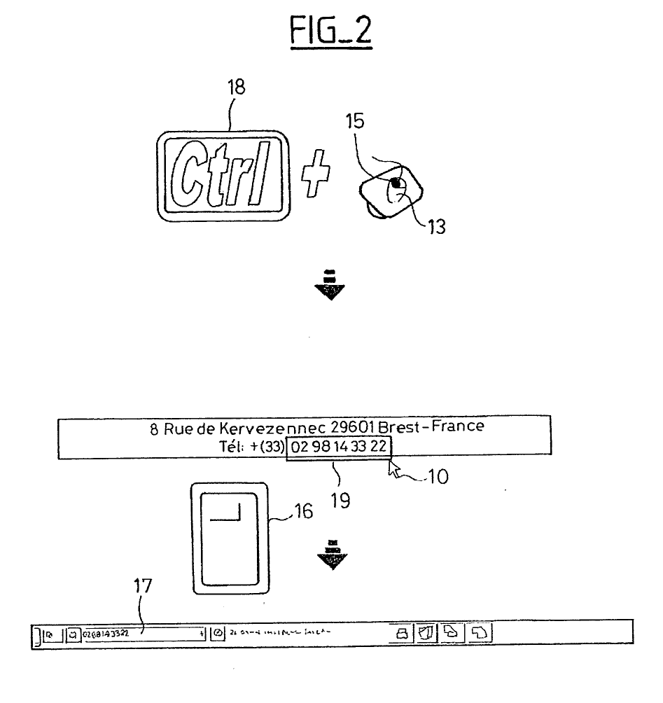

FIG. 2 shows a second implementation of the method of the invention; and

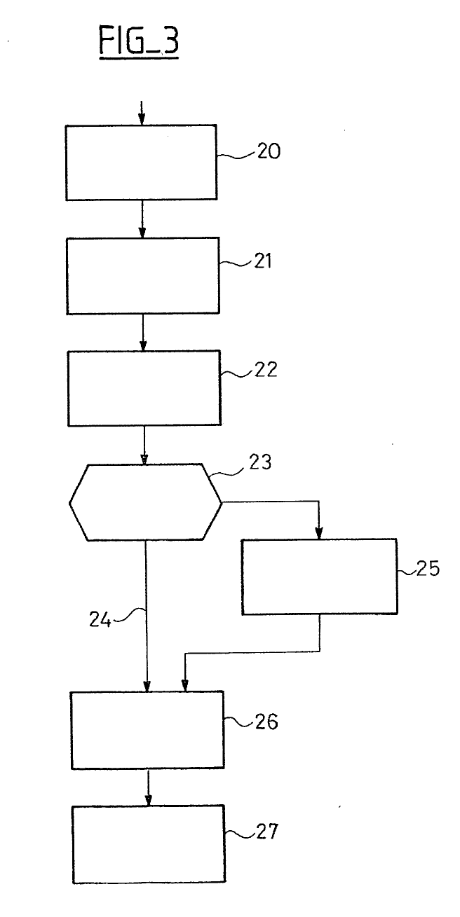

FIG. 3 shows the sequence of operations in an implementation of the method of the invention.

In a first implementation, shown in FIG. 1, the user makes use of a mouse 3 to position a cursor 1 on the screen 2 in the zone of the screen that displays the number to be dialed. The user then launches automatic dialing, e.g. by depressing the SHIFT key 4 while simultaneously pressing the left button 5 of the mouse 3. The computer then displays in a window 7 the number that it had recognized. The user verifies that the number has been properly recognized and then confirms it by pressing the ENTER key, for example. In other examples, the user launches dialing by pressing simultaneously on a predetermined pair of keys.

In a variant, the user drops a “tools” menu and then clicks in succession on options “Character recognition” and “By pointing” in the menu. The user then positions the pointer on the displayed number and finally presses on the left button of the mouse to launch automatic dialing.

Other combinations of commands may be used for confirming telephone number input and launching automatic dialing. By way of example, it is possible to envisage selecting an option from a context menu which is made to appear by clicking on any point of the screen with the right button 6 of the mouse.

FIG. 2 shows a second implementation which consists in capturing a rectangular screen zone containing the string of characters. The user activates a screen zone capture software module by pressing the CTRL key 8 and by pressing simultaneously on the left button 15 of the mouse 13, while moving the mouse along a straight line segment which constitutes a diagonal of the rectangular zone to be captured.

In other implementations, the user presses simultaneously on a predetermined pair of keys or selects a menu option offering optical character recognition based on capturing a zone. The user then slides the cursor 10 while holding down the left button 15 of the mouse 13 so as to draw a rectangle 19 defining the captured zone.

Thereafter the user launches dialing by striking a predetermined key, for example the ENTER key 16. The computer then displays the number it has recognized in a window 17. The user verifies that the number has been properly recognized and then confirms it by pressing the ENTER key 16, for example.

FIG. 3 represents the sequence of operations in an implementation of the method of the invention. Whatever the method used for inputting the string of characters, automatic dialing comprises the following operations:

20) Designating the screen zone (by pointing or by capture) that displays the string of characters corresponding to the number to be dialed, and giving the order to dial the corresponding telephone number.

21) Converting the character string from a graphics format into a digital format using conventional character recognition software.

22) Then transferring the characters in digital form to a conventional automatic dialing software module.

23) Determining whether the characters comprise digits only, or letters, or a mixture.

24) If the character string is a string of numbers, it constitutes directly the telephone number to be called.

25) If the string of characters is an alphabetic string, then the automatic dialing software looks up a number corresponding to said alphabetic string in a directory in conventional manner.

26) Then the number is displayed on the screen for verification by the user. The user confirms the displayed number by pressing the ENTER key.

27) The dialer then dials the number over the telephone line.

1. A method of automatically dialing a telephone number from a string of characters displayed on a computer screen, the method consisting in:
designating (20) the zone of the screen that displays the string of characters corresponding to the number to be dialed, and giving the order to dial the corresponding telephone number;
recognizing (21) each character in the displayed string using an optical character recognition method in order to convert the characters from a graphics format to a digital format;
determining (23-25) a telephone number corresponding to the string of characters converted into digital format; and causing it to be confirmed (26) by the user; and
supplying (27) the digits corresponding to said number in a digital format to telephone number dialing software and causing it to dial the number;
the method being characterized in that in order to determine a telephone number corresponding to the character string, if at least some of the character string is constituted by a name, the method consists in looking up a telephone number corresponding to said name in a directory.

2. A method according to claim 1, characterized in that in order to designate the screen zone displaying a character string, the method consists in pointing to said zone (1) with a pointer device.

3. A method according to claim 1, characterized in that in order to designate the screen zone displaying a character string, the method consists in capturing said zone by tracing a rectangle (19) around said zone with a pointer device.
